(19) United States
(12) Patent Application Publication
(10) Pub. No.: US 2005/0122262 A1
(43) Pub. Date: Jun. 9, 2005

(54) Electronically steerable array antenna for satellite TV

(76) Inventor: Hoon Ahn, Setauket, NY (US)

Correspondence Address: BAKER & BOTTS, 30 ROCKEFELLER PLAZA, NEW YORK, NY, 10112, US

(21) Appl. No.: 10/976,739

(22) Filed: Oct. 29, 2004

Related U.S. Application Data
(60) Provisional application No. 60/516,617, filed on Oct. 31, 2003.

(51) Int. Cl. H01Q 3/26

(52) U.S. Cl. 342/359

(57) ABSTRACT

An antenna is arranged to be mounted on a vehicle and to receive signals, such as television signals, from a geosynchronous satellite. In a preferred arrangement the antenna includes two or three linear arrays of antenna element rows. The arrays each have a linear direction perpendicular to broadside or pointing direction and are angularly oriented with respect to each other to distribute the linear directions around the directions of a plane perpendicular to the broadside direction. The element rows are arranged to form at least one row antenna beam in a direction which is offset from the broadside pointing direction in a plane perpendicular to the linear direction. Phase shifters are arranged to change the phase of signals transmitted or received by antenna elements of each of the rows and a signal combiner/divider is arranged to couple signals between the phase shifters and a transmitter or receiver port of the antenna.

### CROSS-REFERENCE TO RELATED APPLICATIONS

The present application claims priority to U.S. Provisional Application Ser. No. 60/516,617 filed Oct. 31, 2003, which is incorporated herein by reference in its entirety

### BACKGROUND OF INVENTION

This invention relates to antennas for receiving signals from satellites and particularly to arrangements for receiving such signals in a vehicle. Typical household satellite TV receivers use an inexpensive dish antenna which permanently points to the desired geostationary satellite. Such antennas are not suitable for use on vehicles, because they would be required to have a servo drive to keep the antenna pointed at a satellite as a vehicle turns and moves and because the antenna would protrude from the vehicle causing significant wind resistance and detracting from the appearance of the vehicle.

Electronically steered phased array antennas have the capability to electronically point an antenna beam at a satellite to compensate for changes in direction and attitude of a moving vehicle. Such antennas require up to hundreds of electronic phase shifting devices and can be prohibitively expensive to install on a vehicle. U.S. Pat. No. 3,673,606 discloses an antenna for satellite communications that is substantially flush to the surface of a vehicle and provides beam steering via a combination of mechanical rotation and electronic steering in one plane, reducing the required number of phase shifters and the cost of the antenna. Currently available antennas using this approach are externally mounted, for example on the roof of a car, van or aircraft. Such externally mounted antennas can detract from the appearance of the vehicle and are subject to vandalism or theft when the vehicle is parked. Further the antenna has to be frequently removed, such as for washing the car.

It is an object of the present invention to provide a new and improved satellite TV receiving antenna for a vehicle.

### SUMMARY OF THE INVENTION

In accordance with the invention there is provided an antenna having a pointing or broadside direction. The antenna includes a linear array of antenna element rows. The array has a linear direction perpendicular to the pointing direction. Each of the element rows is arranged to form at least one row antenna beam in a direction which is offset from the pointing direction in a plane perpendicular to the linear direction. Phase shifters are arranged to change the phase of signals transmitted or received by antenna elements of each of the rows and a signal combiner/divider is arranged to couple signals between the phase shifters and a transmitter or receiver port of the antenna.

The row antenna beams of the element rows are advantageously offset from the pointing direction by an angle of 30 to 60 degrees. The antenna element rows may be arranged to provide two simultaneous row antenna beams, the two row antenna beams being offset from the pointing direction by opposite and substantially equal angles. The antenna element rows may comprise a plurality of antenna elements having a selected spacing and a signal combiner/divider arranged to provide signals to or from the elements of each row with opposite phase for adjacent elements. Alternately, the antenna element rows can be arranged to provide one of two selectable row antenna beams, the selectable row antenna beams being offset from the pointing direction by opposite and substantially equal angles. In this embodiment the antenna element rows may comprise a plurality of antenna elements having selected spacing, a coupling matrix connected to the elements, having at least two ports, each port corresponding to one of the selectable beams and a switch for selecting one of the ports.

In one preferred arrangement there are two linear arrays provided which are oriented with perpendicular linear directions.

In another preferred embodiment three linear arrays are provided having linear directions arranged 60 degrees from each other.

When multiple arrays are provided they may be arranged within a decorative spoiler for mounting on an automobile. The spoiler may also include at least one additional antenna, such as a Global Positioning System antenna.

The invention includes an antenna system for a vehicle comprising two or more linear arrays and a control system for operating phase shifters and switches of the arrays to cause the antenna to receive signals from a satellite. The control system can be arranged to compensate for the location and directional orientation of the vehicle. The control system may receive signals from a global positioning system to determine location of the vehicle.

For a better understanding of the present invention, together with other and further objects, reference is made to the following description, taken in conjunction with the accompanying drawings, and its scope will be pointed out in the appended claims.

### BRIEF DESCRIPTION OF THE DRAWINGS

FIG. 1 is a plan view of the radiating surface of an array antenna used in an exemplary embodiment of the invention.

FIG. 2 is a drawing illustrating antenna coverage as a portion of a hemisphere.

FIG. 3 is a drawing illustrating antenna beams for an exemplary embodiment of the invention.

FIG. 4 is another drawing illustrating antenna beams for an exemplary embodiment of the invention.

FIG. 5 is a drawing illustrating a configuration for an antenna in accordance with an exemplary embodiment of the invention.

FIG. 6 is a side cross-section view of the FIG. 5 embodiment.

FIG. 7 is a block diagram of an exemplary embodiment of the invention.

FIG. 8 is a block diagram of a system including an antenna in accordance with an embodiment of the invention.

FIG. 9 is a schematic diagram showing an alternate arrangement for the element rows using a matrix and a switch to provide selectable offset beams.

### DESCRIPTION OF THE INVENTION

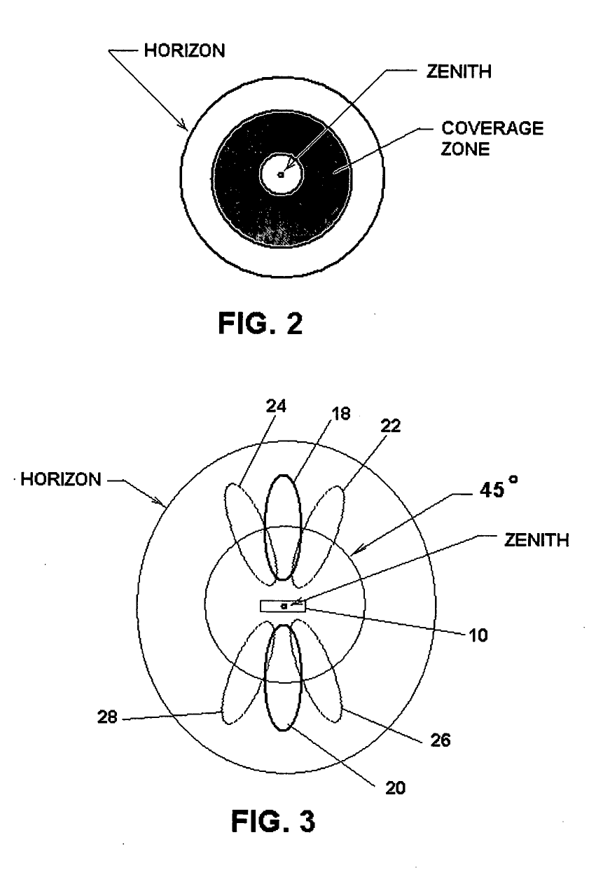

The present invention is based on the recognition that for receiving signals from a geostationary satellite it is seldom necessary to have the antenna beam pointed directly up (zenith) or toward points near the horizon. For reception in largely populated areas, such as North America, Europe or Asia, typical satellite positions are between 30 degrees and 60 degrees elevation. FIG. 2 illustrates the hemispherical coverage zone of interest, which excludes directions near the horizon and near zenith. The shaded areas in FIG. 2 represents directions at which it is desirable to provide antenna coverage.

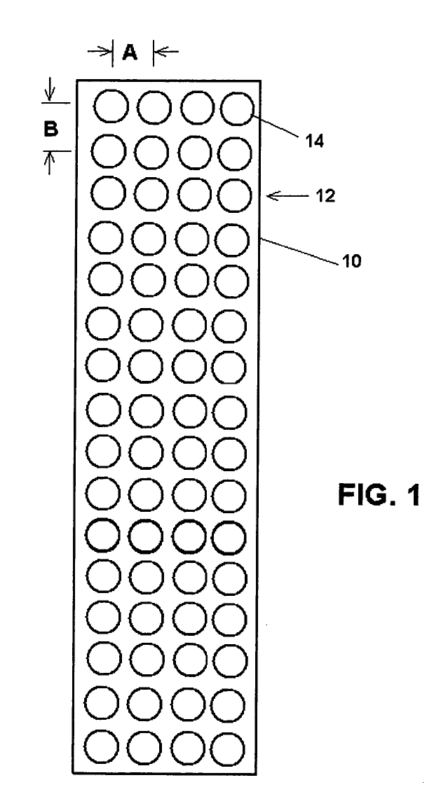

The inventors have discovered that by using a plurality of two or three linear arrays, arranged with linear directions at angles of 90 or 60 degrees with respect to each other in azimuth, it becomes possible to provide antenna coverage in the desired angular directions with only linear electronic scanning. FIG. 3 is another representation of hemispheric directions and shows the configuration of linearly scanned antenna beams from a single linear array 10. One example of a linear array 10 is illustrated in FIG. 1, and includes sixteen rows 12 of four antenna elements 14 per row. The antenna elements 14 of each row are configured to provide either one or two row antenna beams that are offset from the normal (broadside) direction of the array, herein referred to as the pointing direction, by about 30 to 60 degrees, preferably about 45 degrees, in a plane that is transverse to the linear direction of the array. If all the rows are connected to provide or receive signals in phase, the antenna provides one or both of beams 18 and 20, shown in FIG. 3. It will be understood by those skilled in the art that the antenna of the invention is primarily intended for use in receiving signals from a satellite transmitter, but that such antennas are reciprocal in nature and can either transmit or receive signals.

In a first arrangement, the antenna elements can be spaced by an element spacing A of 0.707 wavelengths in the row direction, and are connected to combine signals with alternating phase along the row. This spacing and phasing gives rise to a pair of simultaneous row antenna beams (also called grating lobes) at plus or minus 45 degrees in the broadside plane that is parallel to the rows and perpendicular to the linear array direction.

In a second arrangement the elements of a row can be spaced closer, for example A of 0.45 wavelengths to have no grating lobes and the elements may be connected together by a switchable matrix, such as a Butler matrix to alternately provide a selectable row antenna beam at either plus or minus 45 degrees in the broadside plane that is parallel to the rows and perpendicular to the linear array direction. This configuration has the advantage that it does not suffer from the gain loss associated with multiple lobes in the antenna beam.

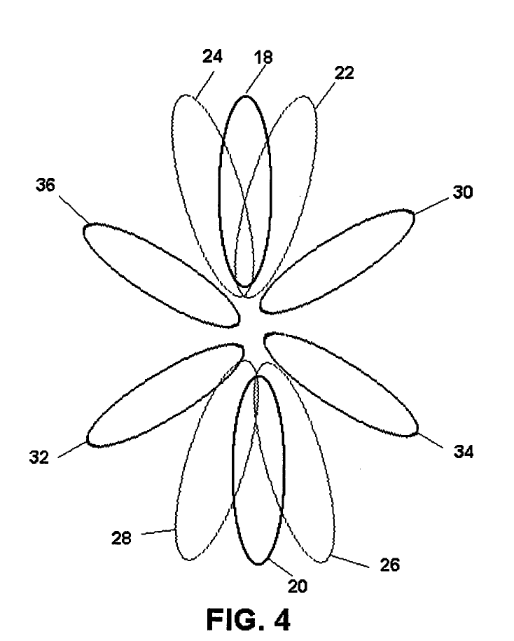

To achieve antenna coverage in the coverage zone shown in FIG. 2, three linear arrays may be provided each having either two offset beams or two selectable beams at the beam locations shown at 18 and 20 of FIG. 3. The linear array direction of each of the three linear arrays is angularly offset by 60 degrees from the other arrays to provide a primary beam set having beams 18, 20, 30, 32, 34 and 36, as illustrated in FIG. 4.

The rows 12 of antenna elements 14 are connected to a signal combiner/divider by phase shifters for electronically scanning the linear array. Those skilled in the art will recognize that many devices, such as power dividers or couplers, can be used to divide signals for the element rows for transmission and to combine signals received by the element rows for reception and such devices are referred to as combiner/dividers. The rows are spaced by a spacing B of about 0.56 wavelengths. Using the phase shifters the two beam positions can be scanned to angular directions between the primary beams. As illustrated in FIG. 3, beam 18 can be electronically scanned to position 22 in one direction or to position 24 in the opposite scanning direction. Likewise beam 20 will scan to position 26 or position 28. The beam scanning is incremental, and the beam can be set to a large number of directions using the phase shifters. Those skilled in the art will recognize that since the array is scanned as a linear array, beam positions 22 and 26 will lie on a cone having its axis along the linear direction of the array. As is evident from FIG. 4, the scanning of the primary beams by plus or minus 30 degrees enables the three array antennas to provide coverage over the entire coverage zone. However, the illustration only shows the primary beams and exemplary scanned beam positions for beams 18 and 20.

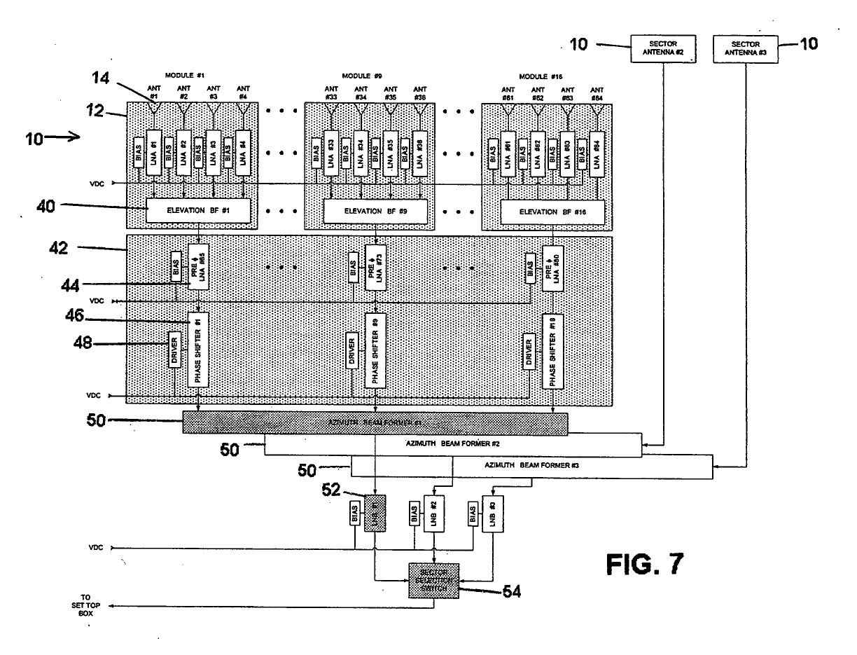

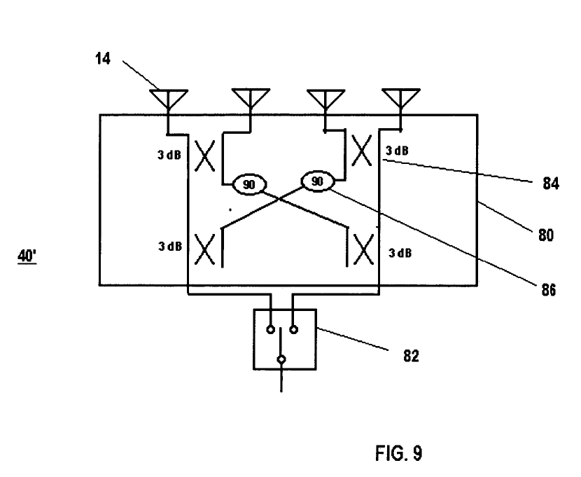

One configuration for the antenna 10 is illustrated in FIG. 7. It is anticipated that the entire RF antenna circuit arrangement will be fabricated as printed circuits, using, for example microstrip transmission line. Antenna elements 14 may be patch antenna elements, which are circularly polarized and switchable between right and left hand circular polarization, and are arranged as part of row modules 12. Row modules 12 may include a low noise amplifier for each antenna element to provide a low overall noise temperature for the system. Modules 12 additionally include row beam forming circuits 40 which combine signals from the antenna elements of a row to form one or both of the primary antenna beams. In the case where the row is to have two beams, the beam forming circuits 40 include a power combiner and possibly phase adjusting elements, such as lengths of transmission line. In the case the row is to have selectable beams, the modules 40 of FIG. 7 are replaced with modules 40′ shown in FIG. 9, which include a multi-beam forming matrix 80 and a beam selector switch 82 to connect one or the other beam outlet to the beam scanning module 42. Multi-beam forming matrix 80 in the exemplary embodiment of FIG. 9 includes four 3 dB. couplers 84, connected by transmission lines having 90 degree phase adjustments 86, as illustrated.

Beam scanning module 42 includes a further low noise amplifier 44, which amplifies the output of each row, followed by a phase shifter 46. A phase shifter 46 is provided for each row 12 of the array 10 to provide phase control of the received signals to provide the electronic beam steering function. The phase shifted signal from each row of the array is combined in beam former 50. Each phase shifter has an associated driver circuit 48, which receives a phase control signal from an antenna control unit 64 to position the received antenna beam according to the location and attitude of the vehicle and the position of the geostationary satellite.

The output of the beam former 50, for example at 12 Ghz. is provided to a low noise block (LNB) down converter 52. The output of the low noise block 52 at an IF of about 950-2000 MHz. for each of three linear arrays is provided to an antenna selection switch 54 which likewise receives control signals from the antenna control unit. Switch 54 selects one of the three linear arrays according to the relative position of the satellite from the vehicle on which the antenna is mounted.

The linear arrays of the invention may be configured as desired, so long as they are oriented about 60 degrees from each other. One configuration for example is along the sides of an equilateral triangle. In some arrangements the linear arrays may depart from being strictly “linear” to be conformal to a surface upon which they are mounted. Although not in a straight line, the arrays would be substantially linear, and it is intended that the term linear includes arrays that are substantially linear.

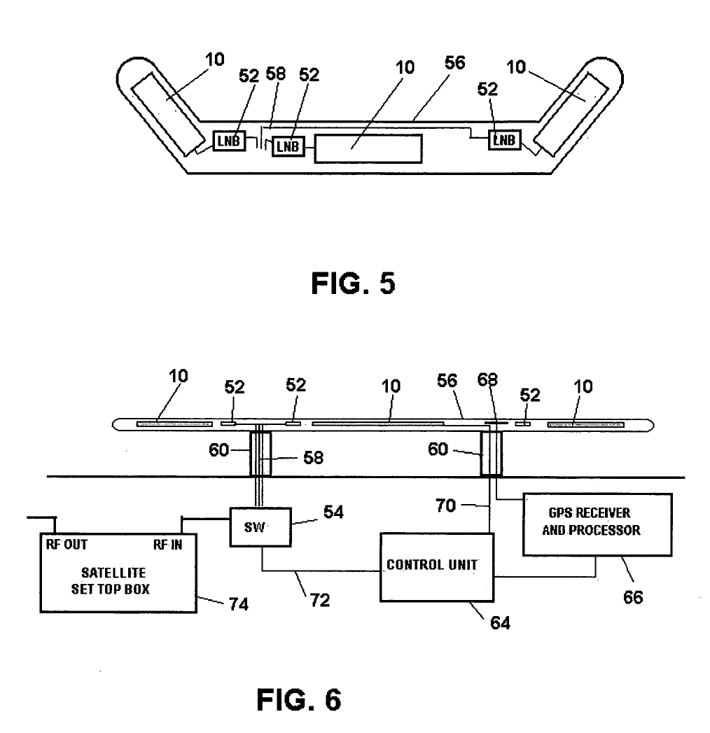

FIGS. 5 and 6 illustrate a configuration for mounting the linear arrays 10 within the body of an automobile “spoiler” 56, which acts as a radome and protects the electronic components. Spoiler 56 is fabricated, for example out of fiberglass or other plastic material and may be finished in a color to be coordinated with the vehicle. Within the spoiler there are provided three linear array antennas 10 and their associated low noise blocks 52, which are connected to selection switch 54 by transmission lines 58, which run through the center of a vertical supporter 60 for the spoiler to switch 54, which may be mounted on the interior of the vehicle, for example within the roof panel or within the luggage compartment. A control unit 64 is mounted within the vehicle and provides control signals to the phase shifter drivers 48 of antennas 10 and to switch 54 through wires 70 and 72. The control unit determines the pointing direction for the antenna beams of antennas 10 either by using a scanning technique to track satellite signals or by using navigation and orientation of the vehicle to determine satellite direction. The received satellite signal which is output from switch 54 is provided to a satellite receiver 74, which provides a signal to a TV receiver or monitor.

In the example illustrated in FIG. 6 there is provided a GPS receiver 66, which may have an antenna 68 located in spoiler 56. Control unit 64 determines the required pointing direction for antennas 10 and selects an antenna according to location determined by the GPS system and orientation of the vehicle, for example determined using a compass. Since the system uses antenna beams that are broad in elevation, it is not sensitive to vehicle tilt.

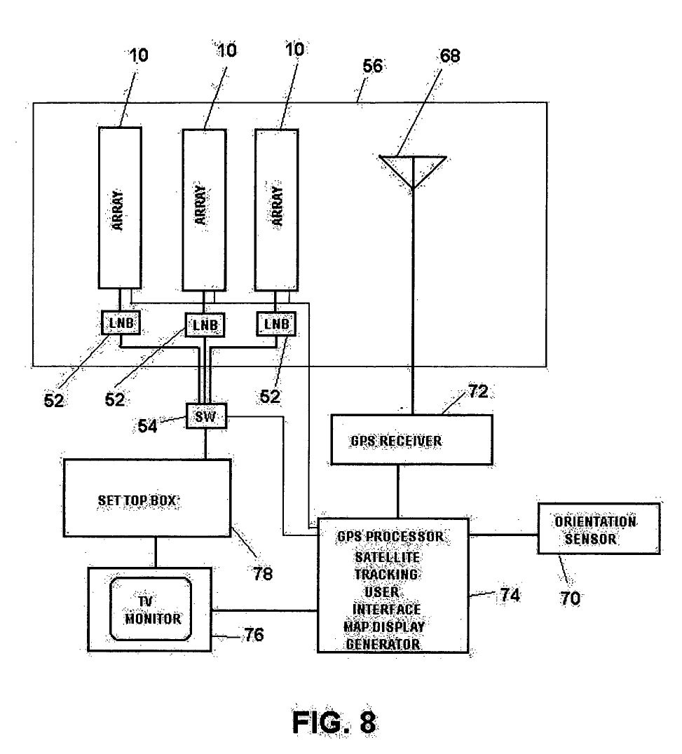

FIG. 8 illustrates a combined system wherein the units are arranged to alternately provide a GPS map display and a satellite television display. This system includes a processor 74 which receives signals from GPS receiver 72 and orientation sensor 70 and determines the pointing control signals and antenna selection signals for the satellite antenna system. The output of the satellite set top box receiver 78 are provided to TV monitor 76. In addition to satellite tracking processor 74 is arranged to respond to a user interface to provide, for example map displays, which may show position and course as an alternate display on TV monitor 76.

In an alternate configuration there may be provided only two linear arrays oriented at 90 degrees to each other. In this case linear scanning will be plus or minus 45 degrees for each linear array to provide the same coverage. Because of the greater scanning the elements need to be arranged closer to each other in the direction of scanning as is well understood in the art.

While there have been described what are believed to be the preferred embodiments of the present invention, those skilled in the art will recognize that other and further changes and modifications may be made thereto without departing from the spirit of the invention, and it is intended to claim all such changes and modifications as falls in the scope of the invention.

1. An antenna having a pointing direction, comprising a linear array of antenna element rows, said array having a linear direction perpendicular to said pointing direction, each of said element rows being arranged to form at least one row antenna beam in a direction which is offset from said pointing direction in a plane perpendicular to said linear direction, phase shifters arranged to change the phase of signals transmitted or received by antenna elements of each of said rows and a signal combiner/divider arranged to couple signals between said phase shifters and a transmitter or receiver port of said antenna.

2. An antenna as specified in claim 1 wherein said row antenna beams of said element rows are offset from said pointing direction by an angle of 30 to 60 degrees.

3. An antenna as specified in claim 1 wherein said antenna element rows are arranged to provide two simultaneous row antenna beams, said two row antenna beams being offset from said pointing direction by opposite and substantially equal angles.

4. An antenna as specified in claim 3 wherein said antenna element rows comprise a plurality of antenna elements having a selected spacing and a signal combiner/divider arranged to provide signals to or from said elements of each row with opposite phase for adjacent elements.

5. An antenna as specified in claim 1 wherein said antenna element rows are arranged to provide one of two selectable row antenna beams, said selectable row antenna beams being offset from said pointing direction by opposite and substantially equal angles.

6. An antenna as specified in claim 5 wherein said antenna element rows comprise a plurality of antenna elements having selected spacing, a coupling matrix connected to said elements having at least two ports, each port corresponding to one of said selectable beams and a switch for selecting one of said ports.

7. An antenna having a pointing direction, comprising two linear arrays of antenna element rows, each said array having a linear direction perpendicular to said pointing direction and perpendicular to the linear direction of the other array, each of said element rows being arranged to form at least one row antenna beam in a direction which is offset from said pointing direction in a plane perpendicular to said linear direction of its corresponding array, phase shifters arranged to change the phase of signals transmitted or received by antenna elements of each of said rows and a signal combiner/divider for each array arranged to couple signals between said phase shifters and a transmitter or receiver port of said array, and a switch for selecting one of said arrays for connection to a transmitter or receiver.

8. An antenna as specified in claim 7 wherein said row antenna beams of said element rows are offset from said pointing direction by an angle of 30 to 60 degrees.

9. An antenna as specified in claim 7 wherein said antenna element rows are arranged to provide two simultaneous row antenna beams, said two row antenna beams being offset from said pointing direction by opposite and substantially equal angles.

10. An antenna as specified in claim 9 wherein said antenna element rows comprise a plurality of antenna elements having a selected spacing and a signal combiner/divider arranged to provide signals to or from said elements of each row with opposite phase for adjacent elements.

11. An antenna as specified in claim 7 wherein said antenna element rows are arranged to provide one of two selectable row antenna beams, said selectable row antenna beams being offset from said pointing direction by opposite and substantially equal angles.

12. An antenna as specified in claim 11 wherein said antenna element rows comprise a plurality of antenna elements having selected spacing, a coupling matrix connected to said elements having at least two ports, each port corresponding to one of said selectable beams and a switch for selecting one of said ports.

13. An antenna having a pointing direction, comprising three linear arrays of antenna element rows, each said array having a linear direction perpendicular to said pointing direction and forming an angle of about 60 degrees with the linear direction of the other arrays, each of said element rows being arranged to form at least one row antenna beam in a direction which is offset from said pointing direction in a plane perpendicular to said linear direction of its corresponding array, phase shifters arranged to change the phase of signals transmitted or received by antenna elements of each of said rows and a signal combiner/divider for each array arranged to couple signals between said phase shifters and a transmitter or receiver port of said array, and a switch for selecting one of said arrays for connection to a transmitter or receiver.

14. An antenna as specified in claim 13 wherein said row antenna beams of said element rows are offset from said pointing direction by an angle of 30 to 60 degrees.

15. An antenna as specified in claim 13 wherein said antenna element rows are arranged to provide two simultaneous row antenna beams, said two row antenna beams being offset from said pointing direction by opposite and substantially equal angles.

16. An antenna as specified in claim 15 wherein said antenna element rows comprise a plurality of antenna elements having a selected spacing and a signal combiner/divider arranged to provide signals to or from said elements of each row with opposite phase for adjacent elements.

17. An antenna as specified in claim 13 wherein said antenna element rows are arranged to provide one of two selectable row antenna beams, said selectable row antenna beams being offset from said pointing direction by opposite and substantially equal angles.

18. An antenna as specified in claim 17 wherein said antenna element rows comprise a plurality of antenna elements having selected spacing, a coupling matrix connected to said elements having at least two ports, each port corresponding to one of said selectable beams and a switch for selecting one of said ports.

19. An antenna as specified in claim 13 wherein said linear arrays are arranged within a decorative spoiler for mounting on an automobile.

20. An antenna as specified in claim 19 wherein said spoiler further includes at least one additional antenna.

21. An antenna system for a vehicle comprising the antenna of claim 13 and a control system for operating said phase shifters and said switch to cause said antenna to receive signals from a satellite, said control system being arranged to compensate for the location and directional orientation of said vehicle.

22. An antenna system as specified in claim 21 wherein said control system receives signals from a global positioning system to determine location of said vehicle.
